(19) United States
(12) Patent Application Publication
(10) Pub. No.: US 2009/0232450 A1
(43) Pub. Date: Sep. 17, 2009

(54) Simple fiber optic cavity

(75) Inventor: Youngmin A. Choi, Agoura Hills, CA (US)

Correspondence Address: Youngmin A. Choi, 5410 Isabella Ct., Agoura Hills, CA, 91301, US

(73) Assignee: Youngmin Albert Choi, Agoura Hills, CA (US)

(21) Appl. No.: 12/150,302

(22) Filed: Apr. 28, 2008

Related U.S. Application Data
(63) Continuation of application No. 10/831,752, filed on Apr. 26, 2004, now abandoned.

(51) Int. Cl. G02B 6/26

(52) U.S. Cl. 385/31

(57) ABSTRACT

A novel Fabry-Perot resonance cavity has been recognized. This cavity is formed by simple planar and concave mirrors that attached at the fiber ends. The concave mirror is precisely aligned to the core of the fiber. The concave lens is fabricated on the thin polymer film by making an indentation of correct geometry and smoothness. The concave mirror has multiple dielectric layers applied on the concave lens to achieve the final, desired optical characteristics.

### FIELD OF THE INVENTION

The present invention relates generally to a simple symmetric or asymmetric resonance cavity. The cavity is formed by either a simple planar and concave mirror (FIG. 2) or two concave mirrors (FIG. 3) which are attached at the end of the each of the fibers. The concave lens is fabricated on the polymer film by making an indentation of correct geometry and smoothness. The concave lens is precisely and easily located to the core of the fiber. The concave mirror has multiple dielectric layers applied on the concave lens such that the final optical characteristics are as desired. This construction is significantly simpler and more reliable than that used in the prior art.

### BACKGROUND OF THE INVENTION

The main problems with conventional optical resonance cavities are their complexity and reliability. These devices are not easily built and much less reliable since they consist of a plethora of devices such as a fiber guide and antireflection coating requiring complex manufacturing steps, and complex alignment fixture. This requires a multitude of manufacturing steps. In addition, properly aligning the mirrors can be difficult and time-consuming, resulting in a complex, less reliable, and expensive resonance cavity. The assembly of such devices is lengthy and problematic requiring complicated alignment and holding fixtures for the mirrors. FIG. 1 is an example of the construction prevalent to date and show the complex structure and precision alignments needed to achieve a cavity. In these respects, the simple resonance cavity according to the present invention substantially departs from the conventional concepts and designs of the prior art, and in so doing, provide an apparatus primarily developed for providing a cavity which can be tuned. In FIG. 1, where like numbers refer to like parts in FIGS. 2 and 3, it can be seen that additional parts (14 and 15) are required and need complex and difficult alignments. Further, the complexity and geometry will lead to instability over temperature. These difficulties are overcome in the current invention which uses a cavity based on a concave dielectric mirror deposited on a suitable material (11) either in conjunction with a planar or second concave mirror. The resulting cavity overcomes the problems with existing art.

### SUMMARY OF THE INVENTION

In view of the foregoing disadvantages inherent in the known types of optical cavities now present in the prior art, the present invention provides a simple resonance cavity construction.

The general purpose of the present invention, which will be described subsequently in greater detail, is to provide a novel optical resonance cavity that has many of the advantages of the optical resonance cavity mentioned heretofore and many novel features that result in a novel optical resonance cavity which is not anticipated, rendered obvious, suggested, or even implied by any of the prior art optical resonance cavity either alone or in any combination thereof.

### BRIEF DESCRIPTION OF THE DRAWINGS

Various objects, features, and attendant advantages of the present invention can be fully appreciated as the same becomes better understood when considered in conjunction with the accompanying drawings, in which like reference characters designate the same or similar parts throughout the several views, and wherein:

FIG. 1A is a view of prior art showing the complexity inherent therein.

FIG. 1B is a view of prior art cavity formed by polished fiber end

FIG. 1C is a view of prior art cavity formed by polished fiber end

FIG. 2 is a schematic view of the asymmetric optical cavity formed between a planar and concave mirror in which a suitable material (11), is attached to fiber (7).

FIG. 3 is a schematic view of the concave mirror deposited on the concave lens formed on the polymer film.

FIG. 4 shows the transmission characteristic of a concave and planar cavity.

FIG. 5 shows the cross section of a shallow micro concave lens profile.

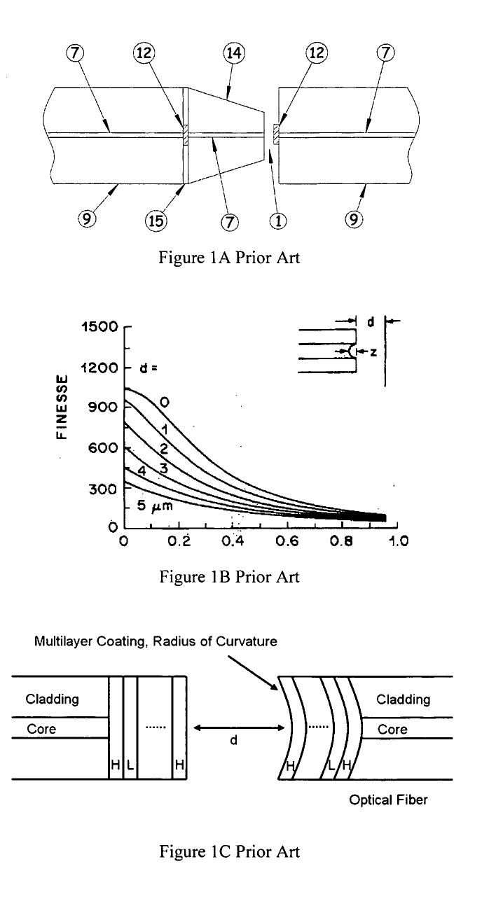

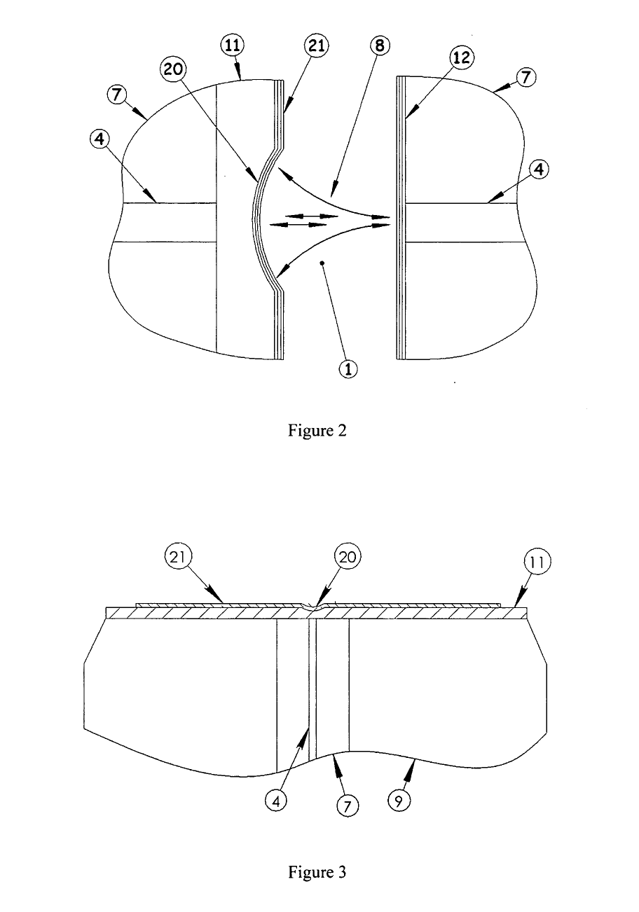

### DESCRIPTION OF THE PREFERRED EMBODIMENT

Turning now descriptively to the drawings, in which similar reference characters denote similar elements throughout the several views, the attached figures illustrate a novel cavity with optical fibers and two mirrors.
In turn:

FIG. 2 shows a schematic view of the asymmetric optical cavity formed between a planar (12) and concave mirror (20). In this case, the concave mirror is precisely aligned to the core of the fiber (4). The planer mirror is located perpendicular to the fiber core. When such a construct is aligned and light in the suitable wavelength range passes through the fiber core, a cavity (1) makes the light (8) to bounce back and forth between the concave and planer surfaces as shown. This cavity is the basis of a multitude of variants, some of which are described herein. A suitable material (11) is bonded to the fiber end (7) to provide a means of creating a concave lens and mirror.

FIG. 3 shows a schematic view of the concave mirror (20) and flat mirror (21). The fiber cladding (7) and core (4) are identified as well as the fiber ferrule (9).

The fiber is an amorphous structure used to guide light. The fiber (7) is composed of fused silica glass with a central core (4) of higher refractive index glass. Light is guided and bound in the core by means of the difference in refractive index between the core and the surrounding glass. In order to protect the glass a single coating or multiple coatings of protective polymer are deposited. The input and output fiber are single mode. While the fibers have been identified as input fiber and output fiber, this does not imply that this is mandatory for operation. Indeed, optical loss and performance are independent of the launch direction with single mode fiber.

The light exits the fiber core (4) into the cavity (1) and begins to expand in a well-defined and understood manner (8). On impinging on the surface of the other fiber, the light is reflected back to the other surface of the fiber where again it is reflected back. Thus, a cavity is made which has multiple reflections between the ends of the fiber. The defining characteristics of the resonant cavity is its loss, wavelength, finesse and free spectral range. The device thus described in operation can also be configured in a plethora of ways and using the same principles measure physical phenomena by monitoring the wavelength of the transmitted light. Further, as described earlier other embodiments are possible and can be used to monitor optical systems. The said device can also be manufactured using existing technologies to yield a low cost, highly reliable, high performance device with reduced complexity and physical size.

The mirror is a structure comprising of a surface with a desired degree of reflectivity and transmittance. The mirrors (12), (20) & (21), are composed of a dielectric coating of finite thickness and composed of multiple layers. One mirror (12) is deposited on the end of an optical fibers (7), which have been suitably prepared to accept such coatings. The other mirrors (20) & (21), are deposited on the end of a polymer lens (11) which is attached to the end of a fiber.

Typically, the fibers (7) are bonded into ferrules (9) which allow for handling and polishing with no damage to the fiber. While fiber ferrules (9) are used in the current embodiment, this is not essential. Indeed, the ferrule does not provide any necessary function other than ease of handling.

While the mirrors (12), (20) & (21), are discussed as separate entities, this does not mean that a separate material be present to provide such a structure. Anyone skilled in the art would know that a mirror is characterized as having specific surface properties. Depending on the required properties, a plethora of techniques can be used to provide such a desired surface. Some of these techniques may use the addition of different materials to achieve the desired properties. The current embodiment utilizes separate materials to provide a medium for the manufacture of a suitable lens structure.

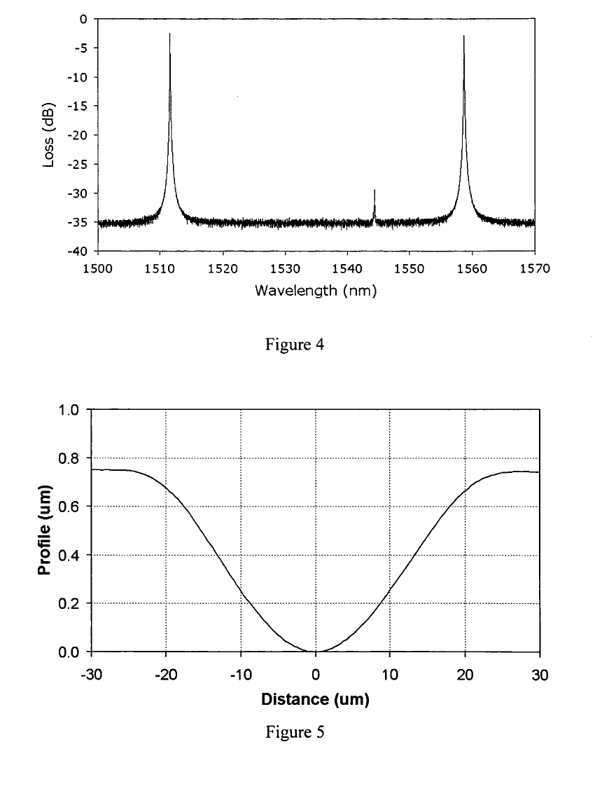

FIG. 4 shows transmission characteristic of a concave and planar cavity as shown in FIG. 2. In this case, the insertion loss is 2.5 dB, the Free Spectral Range (FSR) is 47 nm, the finesse is 610,the parasitic peak is −29 dB as scanned with tunable laser with a −35 dB noise floor. The parasitic peak is due to misalignment and an imperfect concave mirror and is thus a measure of how good these parameters are controlled. Thus, it can be shown that the current invention can achieve excellent, predictable performance from a very simple, controllable construction. By changing the separation of the cavity while maintaining axial alignment, the desired wavelength can be selected. Further, low loss and stability are achieved by the careful selection of material (11) having the desired thickness, surface smoothness and transmittance. In addition to said properties, surface contamination and other defects are eliminated by process control. By having a shallow concave mirror and a small separation between the mirrors, the resulting cavity has a large free spectral range.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A fiber optic resonant cavity with concave mirror and planer mirror comprising;
a) A thin polymer film disposed on the first fiber end;
b) The thin polymer film is optically transparent, smooth, and flat;
c) A shallow and small indentation is made on the polymer film;
d) The indentation on the polymer film has desired curvature and smoothness;
e) The apex of the indentation is aligned to the core of the first fiber;
f) A low loss multilayer broadband dielectric mirror disposed only on the top of the polymer film and the second fiber end;
g) The disposed dielectric mirror on the indentation has same curvature of the indentation;
h) The core of first and second fibers are aligned to form the concave and planar resonance cavity. Thus, the cavity is formed between the concave mirror and planar mirror.
